(19) United States
(12) Patent Application Publication
(10) Pub. No.: US 2022/0203786 A1
(43) Pub. Date: Jun. 30, 2022

(54) METHOD AND ASSEMBLY FOR POSITIONING A VEHICLE RELATIVE TO A TRAILER

(71) Applicant: Continental Automotive Systems, Inc., Auburn Hills, MI (US)

(72) Inventors: Aryan Asgharifard, West Bloomfield, MI (US); Aranza Hinojosa, Ferndale, MI (US)

(21) Appl. No.: 17/137,561

(22) Filed: Dec. 30, 2020

(51) Int. Cl. B60D 1/36; B60R 1/00; B60D 1/64

(52) U.S. Cl. CPC B60D 1/36; B60D 1/06; B60D 1/64; B60R 1/003

(57) ABSTRACT

A method of positioning a vehicle relative to a trailer includes capturing at least one image of a tow ball and a coupler with a camera. The at least one image of the tow ball and the coupler are processed to determine a coordinate of the tow ball and a coordinate of the coupler. A trajectory of the vehicle is determined to align the tow ball with the coupler.

### BACKGROUND

The present disclosure relates to positioning a vehicle relative to a trailer, such as a fifth wheel trailer or a goose neck trailer.

A fifth wheel trailer hitch or a gooseneck trailer hitch are two examples of mid-chassis mounted trailer hitching systems. Mid-chassis mounted trailer hitches differ from traditional trailer hitches adjacent a rear of a vehicle or attached to a rear bumper of the vehicle in that they are located on in mid-portion of the vehicle. The mid-chassis mounted trailer hitches are usually mounted over or in front of a rear axle on the vehicle. The benefits of a mid-chassis mounted trailer hitching system include, but are not limited to, enhanced weight distribution due to the down load at the hitch being over or in front of a rear axle of the vehicle and better vehicle-trailer maneuverability due to the pivot point of the trailer being located closer to the front wheels. A pick-up truck and a chassis cab truck are two examples of vehicles on which mid-chassis mounted trailer hitching systems are commonly mounted.

Many users find it difficult to maneuver a vehicle to align the vehicle-mounted trailer hitching system with the trailer mounted trailer hitching system. When the vehicle mounted hitching system is on a rear of the vehicle, a tradition rear view camera can assist a user in positioning the vehicle relative to the trailer. However, a traditional rear view mounted camera is unable to view a mid-chassis mounted trailer hitch system as it is located forward of the traditional rear view camera and not in view. Therefore, there is a need to aid a user when positioning a mid-chassis mounted trailer hitching system relative to a trailer.

### SUMMARY

In one exemplary embodiment, a method of positioning a vehicle relative to a trailer includes capturing at least one image of a tow ball and a coupler with a camera. The at least one image of the tow ball and the coupler are processed to determine a coordinate of the tow ball and a coordinate of the coupler. A trajectory of the vehicle is determined to align the tow ball with the coupler.

In a further embodiment of any of the above, the at least one image includes a point of view from a rear of a truck cab.

In a further embodiment of any of the above, the ball is located in a midportion of a truck bed and is fixed relative to the truck bed.

In a further embodiment of any of the above, the coupler is located on a fifth-wheel trailer and is configured to directly engage the tow ball.

In a further embodiment of any of the above, processing the at least one image includes identifying a coordinate of the tow ball and a coordinate of the coupling in the at least one image.

In a further embodiment of any of the above, the coordinate of the tow ball and the coordinate of the coupling are in a cartesian coordinate system.

In a further embodiment of any of the above, processing the at least one image includes performing algorithmic image recognition of the at least one image to identify the coordinate of the tow ball and the coordinate of the coupling.

In a further embodiment of any of the above, processing of the at least one image is performed without the use of proximity sensors.

In a further embodiment of any of the above, processing the at least one image includes receiving an identified location of the tow ball in the at least one image by identifying the tow ball on a display showing the at least one image.

In a further embodiment of any of the above, the at least one image includes a plurality of images. Processing the at least one image includes tracking the identified location from the at least one image throughout the plurality of images.

In a further embodiment of any of the above, processing the at least one image includes receiving an identified location of the coupler in the at least one image by identifying the coupler on a display showing the at least one image.

In a further embodiment of any of the above, the at least one image includes a plurality of images and processing the at least one image includes tracking the identified location from the at least one image throughout the plurality of images.

In a further embodiment of any of the above, determining the trajectory includes identifying vehicle dynamics that impact the trajectory.

In a further embodiment of any of the above, the vehicle dynamics include steering angle and a wheelbase of the vehicle.

In a further embodiment of any of the above, determining the trajectory includes optimizing a vehicle path based on the dynamics of the vehicle, a coordinate of the tow ball, and a coordinate of the coupler.

In a further embodiment of any of the above, controlling at least one of a lateral movement or longitudinal movement of the vehicle to following the trajectory to align the tow ball with the coupler.

In another exemplary embodiment, a trailer hitching assist assembly for a vehicle includes a camera. A controller is configured for capturing at least one image of a tow ball and a coupler with a camera. The at least one image of the tow ball and the coupler are process to determine a coordinate of the tow ball and a coordinate of the coupler. A trajectory of the vehicle is determined to align the tow ball with the coupler.

In a further embodiment of any of the above, processing the at least one image includes performing algorithmic image recognition of the at least one image to identify a coordinate of the tow ball and a coordinate of the coupling.

In a further embodiment of any of the above, processing the at least one image includes receiving an identified location of the tow ball and an identified location of the coupler in the at least one image by identifying the tow ball and the coupler on a display showing the at least one image.

In a further embodiment of any of the above, the at least one image includes a plurality of images. Processing the at least one image includes tracking the identified location from the at least one image throughout the plurality of images.

### BRIEF DESCRIPTION OF THE DRAWINGS

The various features and advantages of the present disclosure will become apparent to those skilled in the art from the following detailed description. The drawings that accompany the detailed description can be briefly described as follows.

FIG. 1 illustrates a side view of a vehicle having a mid-chassis mounted trailer hitch.

FIG. 2 illustrates a top view of a bed of the vehicle of FIG. 1 showing a tow ball of the mid-chassis mounted trailer hitch.

FIG. 3 illustrates an example fifth-wheel trailer having a coupler for mating with the tow ball.

FIG. 4 illustrates a schematic of a display on the vehicle, a camera, and a controller in communication with the display and the camera.

FIG. 5 illustrates a method of positioning the tow ball on the vehicle relative to the coupler on the fifth-wheel trailer for attaching the trailer to the vehicle.

### DESCRIPTION

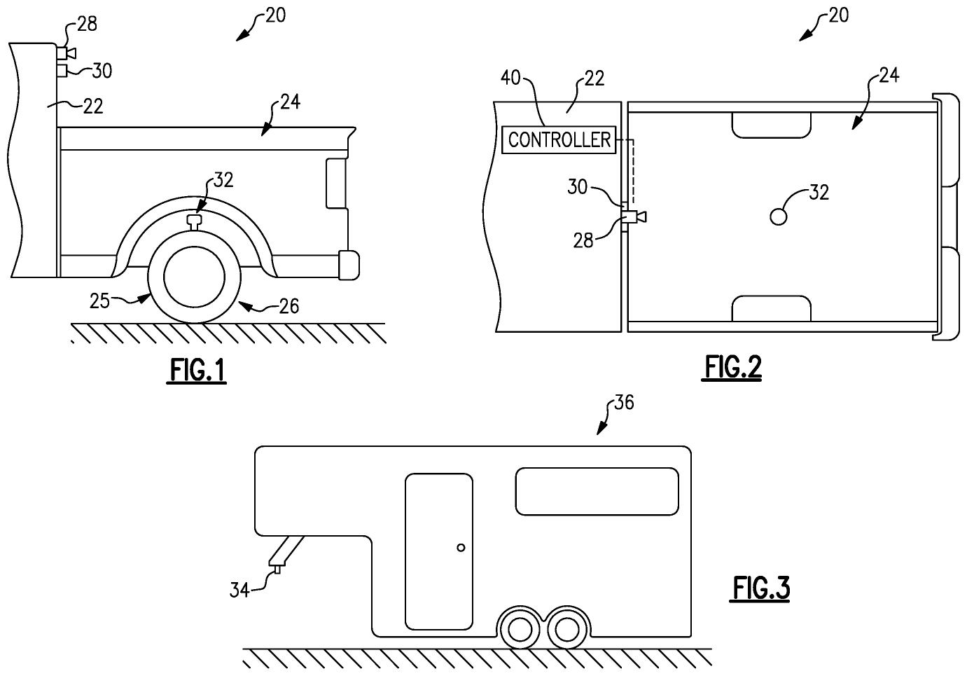

FIG. 1 illustrates an example vehicle 20 for towing a trailer 36, such as the fifth wheel trailer 36 shown in FIG. 3. The vehicle 20 includes a cab 22 for accepting a driver or user of the vehicle 20, a bed 24, and a rear axle 25 supporting a pair of wheels 26. A camera 28 is located on a rear portion of the cab 22 to provide a point of view of the bed 24, the trailer 36, and the surrounding environment. In the illustrated example, the camera 28 is located near or integrated into a rear collision avoidance light 30 on the vehicle 20 at an upper portion of the cab 22.

A fifth wheel trailer 36 is different from a traditional trailer that attaches at a rear of the vehicle 20 because the attachment point is located at a mid-portion of the vehicle 20. This type of hitching system encounters visibility issues that are different from the visibility issues encountered with a traditional hitching system on the rear of the vehicle 20.

As shown in FIGS. 1 and 2, a tow ball 32 as part of the hitching system. The tow ball 32 is located in a mid-portion of the bed 24 and is generally longitudinally aligned with the rear axle 25 or located forward of the rear axle 25. This type of hitching system is generally referred to as a mid-chassis mounted trailer hitching system as it is located forward of a traditional hitch on a rear of the vehicle 20. The tow ball 32 extends vertically from a support surface of the bed 24 and is configured to accept a coupler 34 on the trailer 36 shown (FIG. 3).

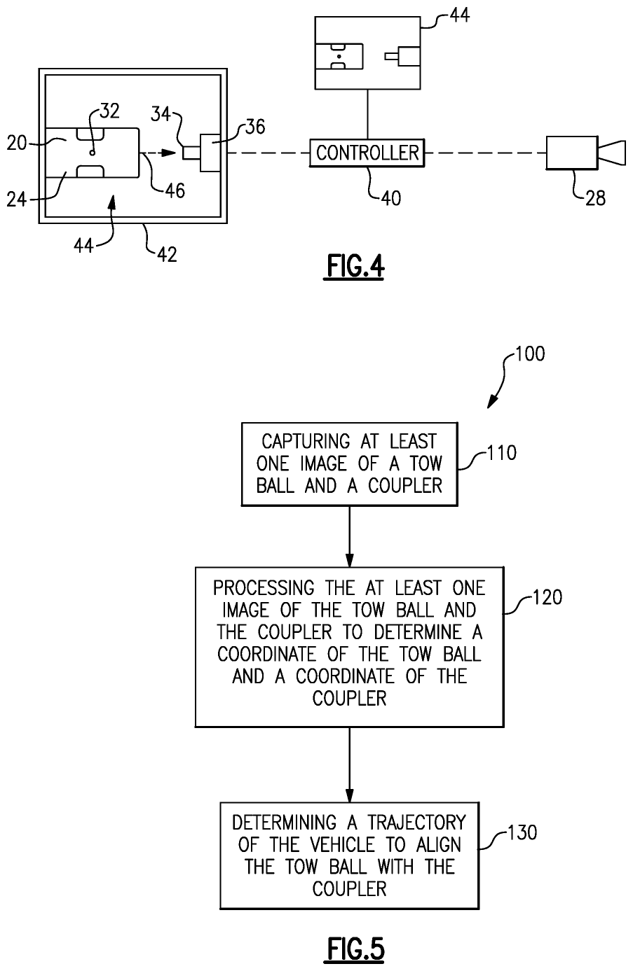

FIG. 5 illustrates a method 100 of positioning the vehicle 20 relative to the trailer 36 in order to align the coupler 36 directly above the tow ball 32. The method 100 includes capturing at least one image 44 (FIG. 4) of the tow ball 32 and the coupler 34 (Step 110). It is assumed that the vehicle 20 is initially positioned in such a way that the coupler 34 on the trailer 36 is within view of the camera 28. If the vehicle is not within view of the coupler 34 on the trailer 36, it should be positioned by the driver until the coupler 34 and the tow ball 32 within view of the camera 28. Additionally, as this disclosure generally discusses identification of the two ball 32 and coupler 36 with respect to a one image 44, the method applies to identify the tow ball 32 and coupler 36 in multiple consecutive images 44 taken as the vehicle 20 moves relative to the trailer 36.

Once the image 44 of the tow ball 32 and the coupler 34 has been captured by the camera 28 and stored on the controller 40, the controller 40 processes the image 44 to identify the two ball 32 and the coupler 34 in the image (Step 120). The controller 40 includes a microprocessor and memory for performing the operations outlined below. The controller 40 may be part of a larger electrical system on the vehicle 20 or it may be dedicated to positioning the vehicle 20 relative to the trailer 36. In particular, if a vehicle 20 already includes a controller in communication with a camera in the location of the camera 28, the controller on that vehicle could be reprogrammed to perform the method 100 outlined in this disclosure.

By processing the image 44 of the tow ball 32 and coupler 34 on the controller 40, the controller 40 is able to determine a coordinate of the tow ball 32 and a coordinate of the coupler 34 in three dimensional space. In one example, the coordinates are base based off of a cartesian coordinate system with a reference point fixed relative to the camera 28. The fixed reference point could include a location on the vehicle 20 that is fixed relative to the camera 28 even while the vehicle 20 is being positioned relative to the trailer 36. This will provide a consistent reference frame for determining the coordinates of the tow ball 32 and the coupler 34.

The controller 40 is able to determine the coordinates of the tow ball 32 and the coupler 34 through performing algorithmic image recognition to identify tow ball 32 and coupler 34 in the image 44. The controller 40 can then determines their relative location based on a fixed reference frame to generate the coordinates of the tow ball 32 and the coupler 36. The controller 40 is able to perform the processing of the at least one image 44 without the use of proximity sensors through the use of image processing and feature tracking of the tow ball 32 and the coupler 34. For example, when processing the image 44, the controller 40 can track the position of the tow ball 32 and the coupler 34 through successive images 44 taken by the camera 28 by identifying features of the tow ball 32 and coupler 34. The controller 40 is able to track the identified features of the tow ball 32 and the coupler 34 between successive images 44 because the identified features remain relatively unchanged while the vehicle 20 is moving relative to the trailer 36.

Furthermore, the feature tracking of the tow ball 32 and the coupler 34 can be assisted by the user. For example, as shown in FIG. 4, the user can identify a location of the tow ball 32 and the coupler 34 from the image 44 projected on a touch screen display 42 located in the vehicle 20. In particular, the controller 40 can prompt the driver through the display 42 when to touch portions of the screen that correspond to the tow ball 32 and the coupler 34. The controller 40 can track the location and features identified by the user of the tow ball 32 and the coupler 34 between successive images 44 by tracking the elements of the tow ball 32 and coupler 34 that remain largely unchanged between successive images 44.

The controller 40 can also determine a trajectory of the vehicle 20 to align the tow ball 32 with the coupler 34 (Step 130). The controller 40 can provide the direction 46 on the display 42 with an arrow to guide the driver towards the trailer 36. Alternatively, the controller 40 can provide information to maneuver a lateral and longitudinal position of the vehicle 20 such that the vehicle 20 is positioned autonomously or semi autonomously. In order to determine the desired lateral and longitudinal position of the vehicle 20, the controller 40 must determine the dynamics of the vehicle 20 that would impact its ability to move laterally and longitudinally. For example, the dynamics could include a maximum steering angle, a wheelbase, and a position of the tow ball relative to an axle on the vehicle 20.

With this information, the controller 40 can optimize a vehicle path needed to align the tow ball 32 directly under the coupler 34 on the trailer 36. The optimized path is at least partially based on the current position of the vehicle 20 relative to the trailer 36, any obstacles in view of the vehicle 20 that may impact the vehicle path, and the current position of the trailer 36. In determining the vehicle path, the controller 40 can evaluate if a vertical height of the coupler 34 is sufficient to prevent impact with a rear portion of the vehicle 20 or with the coupler 34.

With this information, the controller 40 can control the lateral and longitudinal movement of the vehicle 20 to position the vehicle 20 relative to the trailer 36. This allows the vehicle 20 to position the tow ball 32 directly underneath the coupler 34 such that the user will only need to lower the coupler 34 onto the tow ball 32. This allows users of the vehicle 20 that may not be experienced backing up the vehicles 20 to the trailer 36 to more easily do so. Additionally, it allows the vehicle 20 to be connected to the coupler 34 without the need of an additional person outside of the vehicle 20 providing directions to the driver of the vehicle 20 since the driver may be unable to visually see the tow ball 32 and the coupler 34 at the same time.

Although the different non-limiting examples are illustrated as having specific components, the examples of this disclosure are not limited to those particular combinations. It is possible to use some of the components or features from any of the non-limiting examples in combination with features or components from any of the other non-limiting examples.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claim should be studied to determine the true scope and content of this disclosure.

What is claimed is:

1. A method of positioning a vehicle relative to a trailer, comprising:
capturing at least one image of a tow ball and a coupler with a camera;
processing the at least one image of the tow ball and the coupler to determine a coordinate of the tow ball and a coordinate of the coupler; and
determining a trajectory of the vehicle to align the tow ball with the coupler.

2. The method of claim 1, wherein the at least one image includes a point of view from a rear of a truck cab.

3. The method of claim 1, wherein the ball is located in a midportion of a truck bed and is fixed relative to the truck bed.

4. The method of claim 1, wherein the coupler is located on a fifth-wheel trailer and is configured to directly engage the tow ball.

5. The method of claim 1, wherein processing the at least one image includes identifying a coordinate of the tow ball and a coordinate of the coupling in the at least one image.

6. The method of claim 5, wherein the coordinate of the tow ball and the coordinate of the coupling are in a cartesian coordinate system.

7. The method of claim 5, wherein processing the at least one image includes performing algorithmic image recognition of the at least one image to identify the coordinate of the tow ball and the coordinate of the coupling.

8. The method of claim 5, wherein processing of the at least one image is performed without the use of proximity sensors.

9. The method of claim 5, wherein processing the at least one image includes receiving an identified location of the tow ball in the at least one image by identifying the tow ball on a display showing the at least one image.

10. The method of claim 9, wherein the at least one image includes a plurality of images and processing the at least one image includes tracking the identified location from the at least one image throughout the plurality of images.

11. The method of claim 5, wherein processing the at least one image includes receiving an identified location of the coupler in the at least one image by identifying the coupler on a display showing the at least one image.

12. The method of claim 11, wherein the at least one image includes a plurality of images and processing the at least one image includes tracking the identified location from the at least one image throughout the plurality of images.

13. The method of claim 1, wherein determining the trajectory includes identifying vehicle dynamics that impact the trajectory.

14. The method of claim 13, wherein the vehicle dynamics include steering angle and a wheelbase of the vehicle.

15. The method of claim 13, wherein determining the trajectory includes optimizing a vehicle path based on the dynamics of the vehicle, a coordinate of the tow ball, and a coordinate of the coupler.

16. The method of claim 1, including controlling at least one of a lateral movement or longitudinal movement of the vehicle to following the trajectory to align the tow ball with the coupler.

17. A trailer hitching assist assembly for a vehicle, comprising:
a camera; and
a controller configured for:
capturing at least one image of a tow ball and a coupler with a camera;
processing the at least one image of the tow ball and the coupler to determine a coordinate of the tow ball and a coordinate of the coupler; and
determining a trajectory of the vehicle to align the tow ball with the coupler.

18. The assembly of claim 17, wherein processing the at least one image includes performing algorithmic image recognition of the at least one image to identify a coordinate of the tow ball and a coordinate of the coupling.

19. The assembly of claim 17, wherein processing the at least one image includes receiving an identified location of the tow ball and an identified location of the coupler in the at least one image by identifying the tow ball and the coupler on a display showing the at least one image.

20. The assembly of claim 19, wherein the at least one image includes a plurality of images and processing the at least one image includes tracking the identified location from the at least one image throughout the plurality of images.
